(19) United States
(12) Patent Application Publication
(10) Pub. No.: US 2026/0129060 A1
(43) Pub. Date: May 7, 2026

(54) NETWORK PROTECTION SYSTEM

(71) Applicant: DIATTACK YAZILIM BILISIM SIBER GUVENLIK VE DANISMANLIK ANONIM SIRKETI, Istanbul (TR)

(72) Inventors: Ali Aydin KOC, Istanbul (TR); Osman Bahri VARGELOGLU, Istanbul (TR)

(73) Assignee: DIATTACK YAZILIM BILISIM SIBER GUVENLIK VE DANISMANLIK ANONIM SIRKETI, Istanbul (TR)

(21) Appl. No.: 18/704,071

(22) PCT Filed: Aug. 25, 2022
(86) PCT No.: PCT/TR2022/050912

§ 371 Date: Apr. 24, 2024

(30) Foreign Application Priority Data
Dec. 29, 2021 (TR) 2021/021533

(51) Int. Cl. H04L 9/40

(52) U.S. Cl. CPC H04L 63/1425; H04L 63/1416

(57) ABSTRACT

A network protection system detects harmful agents developed to damage a network using a command and control center method by means of an attacker. The system comprises a processor unit, the processor unit is configured to enable an evaluation of traffic flowing over a networked firewall according to status data, to enable a risk analysis to be made according to the risk status of the flow if the flow includes at least one anomaly controlled within the scope of the status data, to enable the preparation of a report containing a score data at the end of the risk analysis, and to enable the report to be transmitted to a user interface via a communication unit on a remote server.

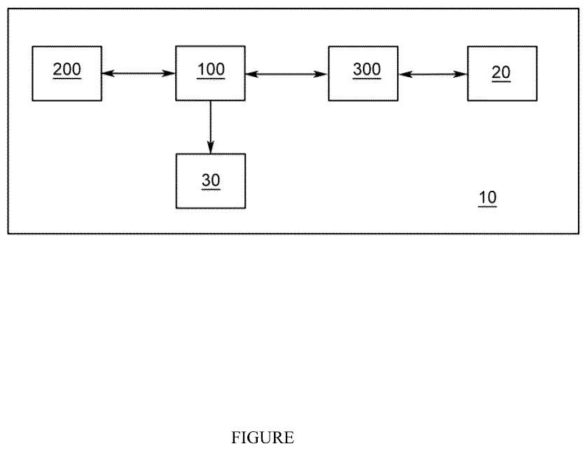

### CROSS REFERENCE TO RELATED APPLICATIONS

This application is a national stage entry of International Application No. PCT/TR2022/050912, filed on Aug. 25, 2022, which is based upon and claims foreign priority to Turkey Patent Application No. 2021/021533, filed on Dec. 29, 2021, the entire contents of which are incorporated herein by reference.

### TECHNICAL FIELD

The invention relates to a network protection system for detecting harmful agents developed to damage a network using the command and control center method by means of an attacker.

### BACKGROUND

Firewalls are used to allow the passage of traffic flowing over the said network or to prevent traffic to ensure the security of a network. The said firewalls can be used for both individual and corporate purposes. Firewalls ensure that the packages received on the network are checked whether they go to the places that they should reach in accordance with the previously defined rules. While firewalls allow the passage of packages that comply with the defined rules, they prevent the passage of packages that do not comply with the existing rules.

While simpler versions of the firewall are available to individual customers, more complex and systematic versions are used for companies. The firewall, which protects the network or computers on the networks within the company against attacks from the internet, controls network traffic between internal and external networks based on predetermined principles. This ensures that a controlled data flow always takes place. Firewalls allow filtering decisions to be made to determine if data is allowed to pass through and reach the user. These decisions are usually based on rules set by the administrator when installing a computer and firewall.

The firewall has changed and developed according to the needs since the first period it was developed. There are three basic types of firewalls belonging to different generations from past to present. These can be listed as first generation package filter firewalls, second generation circuit level firewalls and third generation application level firewalls. First-generation packet filter firewalls include a simple packet filtering technology. Package filter firewalls also allow blocking of packages, etc. When the first generation firewalls were inadequate as a result of network traffic, which became more complicated with the development of technology, a circuit level firewall, also called the second generation, was developed. Second-generation circuit level firewalls can control much more complex network traffic than the first generation in a much healthier and more accurate way. Application-level or proxy-based third-generation firewalls increase security by filtering better during the application phase. Firewalls are expected to continue to change and develop depending on the changing and developing technology.

Some of the security threats of computer networks include malware. Cybercriminals control malware-infected machines through a command and control server (C2) and use these machines to steal confidential information, disseminate malware to additional machines, and engage in malicious activities such as phishing within an organization. According to a McAfee report, more than 300,000 new malware formats and variants are created every day. Accordingly, the global annual cost of the cyber-attack on malware reaches up to 600 billion dollars. Therefore, security mechanisms need to be established to protect networks against malware attacks.

A command and control server is a computer controlled by a cybercriminal. Command and control servers are used by attackers to maintain communication and to send commands to systems within a target network where malware is compromised, to collect and store stolen data. Establishing communications for the command and control server is a vital step for attackers to access network resources.

The attacker starts the first attack by contaminating a computer that can be found behind a firewall. This can be achieved in several ways. One of the aforementioned ways is a phishing email that tricks an employee into clicking a link to a malicious website or opening an attachment that runs malicious code. Another is the vulnerabilities in the browser plug-ins. Another is to download a malicious application. Another is malicious code and infected software that is brought by external devices, for example, a USB stick. The aforementioned paths can be reproduced and may vary depending on the development of technology.

When the security of a machine is compromised, the hacker assigns a callback to the infected computer or device to test the new connection. The said callback is known as a signal sent to the command control center from internal systems. Callback means successful contamination and a violated endpoint. The callback is made periodically at a predetermined frequency. The agent ensures that a signal is transmitted to the command control center at predetermined time intervals. The affected computer then executes the commands on the attacker's command and control server. The attacker can also upload attachments to the affected computer. Thus, the attacker may have full control of the victim's computer. Thus, it can run any code on the computer. Malware can spread from one computer to more computers or proceed through a single entity to remain hidden. A network of infected machines, called the malware Botnet, is being created that spread from one computer to more than one computer. In this way, an attacker who does not have access to a company's network can obtain full control of that network.

In recent years, attackers have been using methods to hide in traffic using various functions for communication between command and control servers and the asset being captured. To prevent malware related damage, security analysts need to quickly identify and remove infected machines that may be on their networks. Identifying and responding to C2 communications is a critical factor in detecting a targeted attack. However, intermittent and low-volume APT C2 traffic is quite difficult to detect, unlike large-scale botnets. Attackers make it even more difficult to change and redirect C2 traffic to addresses, using legal practices and sites as a channel. C2 attacks can pose real dangers to companies, with potentially serious operational, financial and reputational risks.

As a result, all the problems mentioned above have made it necessary to make an innovation in the relevant technical field.

### SUMMARY

The present invention relates to a network protection system to eliminate the above-mentioned disadvantages and bring new advantages to the related technical field.

An object of the invention is to provide a network protection system for detecting harmful agents that have been developed to damage a network using the command and control center method by means of an attacker.

The present invention relates to a network protection system for detecting harmful agents developed to damage a network by using the command and control center method through an attacker to realize all the objects that will emerge from the abovementioned and the following detailed description. Accordingly, its novelty is that it comprises a processor unit, the said processor unit is configured to enable the evaluation of the traffic flowing over a networked firewall according to status data; to enable a risk analysis to be made according to the risk status of the flow if the flow contains at least one anomaly controlled within the scope of the said status data; to enable the preparation of a report containing a score data at the end of the risk analysis; and to enable the report to be transmitted to a user interface via a communication unit on a remote server. Thus, it is ensured that the harmful agents that want to infiltrate a network are controlled on a behavioral basis and a risk score is determined according to the monitored behavioral characteristics. At least one official is informed about the determined risk score.

A possible embodiment of the invention is characterized in that the said state data comprises at least one predetermined information to define at least one signaling between the harmful agent and the command control center.

Thus, it is ensured that the movements that harmful agents can make on the basis of behavior are controlled.

Another possible embodiment of the invention is characterized in that the processor unit is configured to enable the evaluation of flow traffic with predetermined models using statistical and the machine learning methods. Thus, real-time monitoring and control can be ensured by keeping the data up-to-date against harmful agent software.

Another possible embodiment of the invention is characterized in that the processor unit is configured to be connected to at least one database storing the previously detected harmful agent information.

Another possible embodiment of the invention is characterized in that the processor unit is configured to enable the IP containing the flow to be compared with the IPs stored in the database during the flow evaluation. Thus, previously recognized and stored harmful agents can be easily identified.

Another possible embodiment of the invention is characterized in that the processor unit (100) is configured to record the detected anomaly states to a memory unit. Thus, it is easy to identify the detected harmful agents in case of recurrence. This helps to reduce time loss.

### BRIEF DESCRIPTION OF THE DRAWINGS

Figure shows a representative view of a network protection system.

### REFERENCE NUMBERS GIVEN IN THE FIGURE

10 Network protection system
100 Processor unit
200 Memory unit
300 Communication unit
20 User interface
30 Database

### DETAILED DESCRIPTION OF THE EMBODIMENTS

In this detailed description, a network protection system of the invention is explained with examples that do not have any limiting effect only for a better understanding of the subject.

The invention relates to a network protection system (10) for detecting harmful agents developed to damage a network using the command and control center method by means of an attacker.

The said network protection system (10) comprises a processor unit (100) configured to enable the reading of computer-based software commands and the execution of the read software commands. In a possible embodiment of the invention, the said processor unit (100) may be a computer, a microcontroller, etc. There is a memory unit (200) to which the processor unit (100) is associated to allow data reading and data writing. There is a communication unit (300) provided to exchange data between the processor unit (100) and a server. There is a user interface (20) provided to provide data to a user associated with the processor unit (100). In an exemplary embodiment of the invention, the user interface (20) may be a digital display, a computer display, etc. The said network protection system (10) includes multiple software commands stored in the memory unit (200). When the said software commands are read through the processor unit (100), it is ensured that the operations that enable the detection of harmful agents and inform the user are carried out over the firewall.

The firewall enables the examination and filtering of the traffic passing over it. If the firewall detects an anomaly in the traffic flowing over it, it prevents its passage. In this case, it allows the anomaly whose transition is prevented to be saved to memory. When controlling the traffic flow, the external firewall first allows the data to be compared with the anomalies previously recorded in the memory. The external firewall allows flow passage if it realizes that the flow does not match the anomaly states in the memory as a result of the comparison.

In the network protection system, the processor unit (100) enables the status information of a rope passing through the external firewall to be tracked historically. The processor unit (100) also allows comparing the traffic flowing through the external firewall with anomaly models detected using methods such as statistical and machine learning. The network protection system (10) provides the development of the analytical model by collecting the activities collected on the external firewall in real time and comparing the new traffic traces with the previous period traffic traces. In an exemplary embodiment of the invention, it is ensured that the unsupervised k-means hierarchical clustering model is used in the anomaly model to be developed for the behavior detection of the harmful agent by using firewall activities. In an exemplary embodiment of the invention, it is ensured that the Kohonen neural network model is used in the anomaly model to be developed for the behavior detection of the harmful agent by using firewall activities. In an exemplary embodiment of the invention, it is ensured that the isolation forest model is used in the anomaly model to be developed for the detection of the behavior of the harmful agent by using firewall activities. In an exemplary embodiment of the invention, it is ensured that the RRCF (Robust Random Cut Forest) model is used in the anomaly model to be developed for the behavior detection of the harmful agent by using firewall activities. In an exemplary embodiment of the invention, it is ensured that the surveillance (Adaboost, Naive Bayes, Random Forest, RIPPER (repeated incremental pruning to produce error reduction), SVM) model is used in the anomaly model to be developed for the detection of the behavior of the harmful agent using firewall activities. In an exemplary embodiment of the invention, it is ensured that hidden Markov models are used in the anomaly model to be developed for the detection of the behavior of the harmful agent by using firewall activities. In an exemplary embodiment of the invention, it is ensured that the Bernard's Law model is used in the anomaly model to be developed for the detection of the behavior of the harmful agent by using firewall activities. In an exemplary embodiment of the invention, it is ensured that the time series analysis (Identifying malicious hosts involved in periodic, 2017) model is used in the anomaly model to be developed for the behavior detection of the harmful agent using firewall activities. The developed mathematical model enables the detection of the harmful agent controlled through the command and control center. The processor unit (100) also allows the IP information of the harmful agent to be stored in the memory unit (200). The processor unit (100) ensures that the IPs showing the command and control center behavior but generating legal traffic are transmitted to the server through the communication unit (300). A remote user can access the information of the detected malicious agent by connecting to the server via the user interface (20). The processor unit (100) also provides the user with an option to prevent threats through the user interface (20). The processor unit (100) can ensure that security threats are prevented if the user approves the option.

An exemplary operating scenario of the invention is described below;

A harmful agent developed through the command control center is placed on an area on the network by passing through the outer firewall. The malicious agent provides a feedback signal to the command control server regarding the location where it is located on the network. The feedback signal also includes information that allows the malware agent to request a task from the command control server to perform. The harmful agent provides the feedback signal to the command control center at predetermined time intervals. The processor unit (100) ensures that the traffic flowing through a networked firewall on the network is evaluated according to status data. The said status data comprises at least one predetermined information to define at least one signaling between the harmful agent and the command control center. There are several methods for identifying this signaling between the pest agent and the command control center. The harmful agent can make this feedback signal with irregular forms of communication that occur with randomly determined functions. In addition, the signals sent by the harmful agent can be provided in similar sizes. Furthermore, feedback signals sent from the command control center to the malware agent may include long links. In addition, methods such as TCP Flag information, Transportation Protocol, Application Protocol etc. are also used to define the aforementioned signaling. The methods used can be developed without being limited to them. It can also be updated depending on technology.

The processor unit (100) enables the detection of where the signal comes from within the network if at least one of the controlled criteria is detected. The processor unit (100) enables the control of the data stored in the auxiliary units to detect the harmful agent. In a possible embodiment of the invention, a network access control system (NAC) provided to the institution may be used as an auxiliary unit. In a possible embodiment of the invention, it is ensured that endpoint threat detection and response system (EDR) products are used as an auxiliary unit. In a possible embodiment of the invention, the unit detected by the internal firewall and recorded in memory is used as an auxiliary unit. In a possible embodiment of the invention, it is ensured that the data filtered and stored in the memory by the external firewall is used as an auxiliary unit. In a possible embodiment of the invention, blacklist and whitelist are used as auxiliary units. In a possible embodiment of the invention, the organizational security information and event management unit (SIEM) are used as an auxiliary unit.

The processor unit (100) enables the evaluation of the risk status according to the location of the detected malware on the network and the function it performs. For example, the fact that the harmful agent is signaled with a content registered in the blacklist indicates that the agent is malicious, in this case, it is stated that the detected agent is malicious with a score of 10 out of 10. According to another example, if it is determined that a signal is continuously transmitted over an IP in the network, that the said signals are of certain dimensions and that the said signal is repeated at certain time intervals, but is over an IP other than the authorization definition on the network, a risk scoring is made that the IP contains 5 out of 10 malware. The processor unit (100) ensures the preparation of a report with the risk score and the data obtained. The processor unit (100) enables the prepared report to be transmitted to a user interface (20) via a server through the communication unit (300). Thus, it allows the user to control the IP containing the harmful agent.

In an alternative embodiment of the invention, if the user enters a command to clean the harmful agent through the user interface (20), the processor unit (100) can be used to clean the harmful agent over the network. Thus, the network is protected against harmful agents. The processor (100) unit also allows the detected harmful IP to be stored in the memory unit (200). The processor unit (100) also enables the detected malicious IP to be stored in the memory of the defined database (30). Thus, the external firewall in particular allows the said harmful agent to be filtered in the event of reoccurrence of the harmful agent. The processor unit (100) enables real-time monitoring and tracking of the traffic flowing through the firewall.

In a preferred embodiment of the invention, data can be shared with a database containing national attacks organized specifically for the country.

The scope of protection of the invention is specified in the attached claims and cannot be limited to those explained for sampling purposes in this detailed description. It is evident that a person skilled in the art may exhibit similar embodiments in light of the above-mentioned facts without drifting apart from the main theme of the invention.

1. A network protection system for detecting harmful agents developed to harm a network using a command and control center method by means of an attacker, comprising:
a processor unit, the processor unit is configured to enable an evaluation of traffic flowing over a networked firewall according to a status data; to enable a risk analysis to be made according to a risk status of a flow if the flow contains at least one anomaly controlled within the scope of the status data; to enable the preparation of a report containing a score data at the end of the risk analysis; and to enable the report to be transmitted to a user interface via a communication unit on a remote server.

2. The network protection system according to claim 1, wherein the status data includes at least one predetermined information to define at least one signaling between the harmful agent and the command control center.

3. The network protection system according to claim 1, wherein the processor unit is configured to evaluate the traffic flowing with predetermined models using statistical and machine learning methods.

4. The network protection system according to claim 1, wherein the processor unit is configured to be connected to at least one database that stores previously detected harmful agent information.

5. The network protection system according to claim 1, wherein the processor unit is configured to compare IP containing the flow with IPs registered in the database during the flow evaluation.

6. The network protection system according to claim 1, wherein the processor unit is configured to record detected anomalies to a memory unit
